(19) United States
(12) Patent Application Publication
(10) Pub. No.: US 2011/0104456 A1
(43) Pub. Date: May 5, 2011

(54) DECORATIVE ELEMENTS AND MANUFACTURING METHOD THEREOF

(76) Inventor: Laurent Boissin, Hyeres (FR)

(21) Appl. No.: 12/989,919

(22) PCT Filed: Apr. 24, 2009
(86) PCT No.: PCT/IB09/05362

§ 371 Date: Dec. 13, 2010

(30) Foreign Application Priority Data
Apr. 29, 2008 (FR) 08 02 396

(51) Int. Cl. B32B 5/00; B05D 5/06; B41J 2/015

(52) U.S. Cl. 428/195.1; 427/261; 427/258; 347/20

(57) ABSTRACT

The invention relates to a decorative element including: A substrate (2) made of a material including cement hydrates and calcium hydroxide and/or carbonate; an intermediate layer (3) arranged on the substrate (2), including calcium hydroxide and/or carbonate; and a picture layer (7), arranged on the intermediate layer (3), including pigments. The invention also relates to a method for manufacturing this decorative element and a method for manufacturing a decoration including the use of one or more of such decorative elements.

### FIELD OF THE INVENTION

The present invention relates to decorative elements and the production thereof, and the use of one or more of such decorative elements to form a decoration, in particular a mural decoration.

### TECHNICAL BACKGROUND

Several methods are known for forming a decoration, in particular a complex and large image, on a mural substrate. Setting aside the techniques that consist of painting or printing an image on a flexible substrate (fabric, wail covering, paper, plastic film, etc.), the main method used since time immemorial is the fresco.

The traditional fresco technique consists of coating a wall with successive layers of mixtures of lime and sand, the sand being increasingly fine, and then painting an image by hand on the last layer (known as intonato) when it is still fresh. Although this technique is still sometimes used today, it is extremely costly as firstly, it is particularly difficult to master, and secondly it remains an artistic technique that is impossible to implement on an industrial scale, as it is necessary to paint the image by hand.

In order to implement a less costly decorative technique, on an industrial scale, it is necessary to have small decorative elements that each contain part of the image of the decoration, which can be produced on a production site and then transported to the installation site and assembled on a mural substrate to reconstitute the complete image using a mosaic system.

However, the decorative elements of this type that are currently available remain unsatisfactory. For example, decorative elements of the earthenware tile type (or similar) require firing in a kiln to ensure that the pigments adhere to the substrate material. Besides the fact that such firing requires complex and costly equipment for implementation, it also makes it impossible to use the modern inks that are used in digital printing devices. Thus, it is difficult to envisage reconstituting decorations consisting of complex images (reproduction of a picture or photograph for example) from such decorative elements.

The use of other types of substrate (aluminium or plastic panels, wood, glass, cardboard) is not entirely satisfactory either, because the adherence of the inks to these substrates is insufficient or because the substrates themselves are perceived to be of mediocre quality.

Furthermore, the attempts made to date to print an image on a decorative element formed from building materials have failed. Thus, the inks adhere poorly to stone as well as cement- or plaster-based substrates, the surface of which tends to be powdery, or even brittle. In use, the inks flake quickly.

Document WO 2006/040480 proposes an alternative according to which a flexible substrate (plastic or textile) is provided, onto which an image is printed, and the whole thing is then glued to the surface to be decorated. This method renders the surface impermeable and is not sufficiently durable.

There is therefore a real need to develop decorative elements that allow for the reconstitution of a decoration, particularly mural, in the form of a complex image, said decorative elements being able to be produced industrially and having satisfactory properties of strength, ink adherence to the substrate and durability.

### SUMMARY OF THE INVENTION

The invention relates firstly to a decorative element comprising:
a substrate formed from a material comprising cement hydrates and calcium hydroxide and/or carbonate;
an intermediate layer arranged on the substrate, comprising calcium hydroxide and/or carbonate;
a picture layer arranged on the intermediate layer, comprising pigments.

According to an embodiment, the picture layer comprises at least one hardened photosensitive ink film, of uniform colour or forming an image.

According to an embodiment, the picture layer comprises a first photosensitive ink film of uniform colour, arranged on the intermediate layer, together with a second photosensitive ink film forming an image, arranged on the first film.

According to an embodiment, the decorative element also comprises a base structure on which the substrate is arranged, said base structure preferably being a building panel or board.

According to an embodiment, the decorative element also comprises a protective layer arranged on the picture layer, preferably made from wax.

According to an embodiment, the substrate material comprises:
20 to 80%, preferably 30 to 70%, more particularly preferably 40 to 60%, ideally 45 to 55% by mass of cement hydrates; and
20 to 80%, preferably 30 to 70%, more particularly preferably 40 to 60%, ideally 45 to 55% by mass of calcium hydroxide and/or carbonate.

According to an embodiment, the intermediate layer comprises at least 60%, more particularly preferably at least 80%, advantageously at least 90%, ideally at least 95% by mass of calcium hydroxide and/or carbonate.

According to an embodiment:
the substrate has a thickness of between 0.2 and 10 cm, preferably between 0.3 and 5 cm, more particularly preferably between 0.4 and 2 cm; and/or
the intermediate layer has a thickness of between 0.1 and 5 mm, preferably between 0.3 and 3 mm, more particularly preferably between 0.5 and 2 mm; and/or
the picture layer has a thickness of between 0.2 and 10 μm, preferably between 0.5 and 5 μm, more particularly preferably between 0.8 and 3 μm; and/or
the protective layer has a thickness of between 0.2 and 5 preferably between 0.5 and 3 μm, more particularly preferably between 0.8 and 2 μm.

A further object of the invention is a production method for a decorative element, comprising successively:
the supply of a substrate formed from a material comprising cement hydrates and calcium hydroxide and/or carbonate;
the supply of a plaster comprising lime and water;
the formation of an intermediate layer on the substrate by application of the plaster;
the deposition of pigments on the intermediate layer, said intermediate layer being damp during deposition; and
the drying of the intermediate layer.

According to an embodiment, the method also comprises the prior production of the substrate through the casting, setting and drying of a wet substrate mixture comprising cement and lime, the cement and lime preferably being in a mass ratio of 1:4 to 4:1, particularly preferably 3:7 to 7:3, ideally 2:3 to 3:2, or even 9:11 to 11:9.

According to an embodiment, the wet substrate mixture is cast in a mould or is cast on a base structure, said base structure preferably being a building panel or board.

According to an embodiment, the deposition of pigments consists of printing a photosensitive ink film forming an image, by means of a digital printer.

According to an embodiment, the deposition of pigments takes place through the application of a photosensitive ink film of uniform colour.

According to an embodiment, the method comprises an additional stage of deposition of pigments after the drying of the intermediate layer, preferably by printing a photosensitive ink film forming an image, by means of a digital printer.

According to an embodiment, the method comprises a final stage of coating with protective material, preferably wax.

According to an embodiment of the method, the aforementioned decorative element is as described above.

A further object of the invention is a decorative element that can be produced according to the method described above.

A further object of the invention is the use of one or more of the above decorative elements for the production of a decoration, in particular a mural decoration.

A further object of the invention is a production method for a decoration, comprising:
the assembly and fixing of one or more decorative elements as described above, said decorative elements being flat, on a flat surface, which is preferably a wall;
optionally, the jointing of the fixed decorative elements; and
optionally, the application of a protective layer, preferably wax, on the fixed decorative elements.

The present invention can be used to overcome the drawbacks of the state of the art. It provides more particularly decorative elements that can be produced industrially and have satisfactory properties of strength (for example compressive strength) and adherence of the ink to the substrate. These decorative elements can be used to reconstitute by juxtaposition a decoration, particularly mural, in the form of a complex image.

This is achieved through the use of a lime-based substrate, onto which at least a first ink film is applied when the substrate is still damp. The advantages of the ancient fresco technique can thus be enjoyed (exceptional durability of the product, due to the gradual carbonation of the painted or printed surface). The great flexibility of use of a structure made from solid (strong) and movable decorative elements, which can be produced industrially, optionally sold, and then assembled on an installation site far from the production site, can also be enjoyed.

According to certain particular embodiments, the invention also has the advantageous characteristics set out below.
The invention makes it possible to use modern digital printing techniques on a product with physical and structural properties similar to those of ancient frescoes. Digital printing allows for the reproduction of any type of complex image, of a painting or photograph type, in a very simple manner.
Over the months and years, the assembled decorative elements acquire a characteristic patina.
The carbonation of the surface, combined with the optional presence of a layer of wax coating the decorative elements, protects the surface from wear and dirt while allowing the material to continue to breathe and develop.

### BRIEF DESCRIPTION OF THE FIGURES

FIG. 1 is a diagrammatic representation of a cross-section of a decorative element according to the invention.

### DESCRIPTION OF EMBODIMENTS OF THE INVENTION

The invention will now be described non-limitatively in further detail in the following description.

Decorative Elements and their Production

The decorative elements according to the invention are mobile elements. Although they can be of any shape, they are advantageously in the form of boards or tiles. Preferably the boards are rectangular or square, with a thickness smaller than the length and width by a factor greater than or equal to 10.

As an example, the decorative elements can be boards with a thickness of between 0.5 and 5 to 10 cm, preferably between 1 and 2 cm, the length and width each being between 5 and 200 cm, preferably between 10 and 40 cm. When a printer is used during the production of the decorative elements, the maximum dimension of the decorative elements will generally be limited by the maximum printing area of the printer.

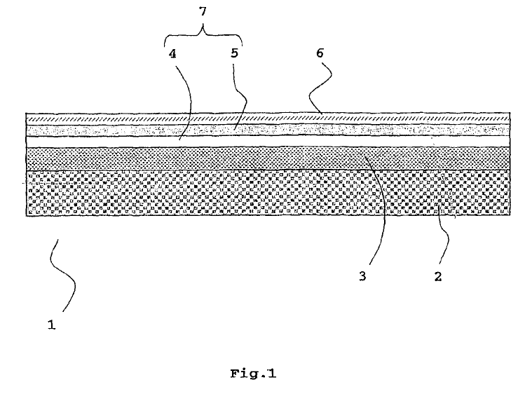

With reference to FIG. 1, a decorative element 1 according to the invention comprises a substrate 2, an intermediate layer 3, a picture layer 7 and a protective layer 6.

The decorative element is produced by successive formation of the different layers, starting with the substrate 2.

The substrate 2 is formed by deposition and forming of a wet substrate mixture. Preferably, a mould is used in which the mixture is cast.

However, according to a specific embodiment (not shown), the wet substrate mixture can be poured (that is, deposited) onto a base structure. The base structure is then part of the finished decorative element and constitutes an additional layer, underneath the substrate.

Conversely, with moulding, it is possible to obtain a decorative element without such a base structure. It is however also possible to provide a base structure in the bottom of the mould to constitute an additional layer of the decorative element (underneath the substrate).

Still with moulding, it is also possible to provide a reinforcing structure in the bottom of the mould, intended to be incorporated into the substrate itself; this reinforcing structure can be for example a reinforcement or a mesh.

The embodiment in which a base structure is used is particularly advantageous for decorative elements with a relatively large area (for example 1 m² or more).

A prefabricated building panel or board is preferably used as a base structure. The base structure must be chosen so that it has good adherence vis-à-vis the application of a plaster or tile adhesive, as well as low putrefying capacity in the presence of moisture. For example a plywood board can be used as a base structure, or a board comprising a core of hard extruded polystyrene foam (of the “Styrofoam” type), reinforced on either side by a glass fibre reinforcing mesh, said mesh being coated with a plasticized mortar. Boards trade marked WEDI are examples of such boards.

The wet substrate mixture is obtained mainly by mixing lime, cement and water. The cement and lime can be present in the mixture in a mass ratio of 1:4 to 4:1, particularly preferably 3:7 to 7:3, ideally 2:3 to 3:2, or even 9:11 to 11:9. For example the cement and lime can be present in a mass ratio approximately equal to 1:1. The mixing water can be present in a mass ratio of between 30 and 60%, preferably between 35 and 55%, ideally between 40 and 50% relative to the total mass of the mixture.

The main role of the cement is to confer satisfactory strength, that is in particular compressive strength, upon the substrate 2 and therefore the decorative element 1.

Any type of cement can be used as the cement, and in particular any cement defined in standard EN 197-1. This can be for example Portland cement (CEM I), a blended Portland cement (CEM II), a Portland blastfurnace cement (CEM III), a pozzolan cement (CEM IV), a slag-ash cement or a blended cement (CEM V).

Air-slaked or hydraulic lime can be used as the lime.

The wet substrate mixture can also comprise various additives, in a mass ratio of 0 to 30%, preferably 5 to 20%, relative to the total dry mass of the mixture.

It is for example possible to include additional binders or fillers as additives, in particular natural or synthetic pozzolans, slag, fly ash, silica fume, kaolin, metakaolin or mixtures of these materials.

Although, according to a particular embodiment, the substrate mixture does not contain aggregates, it is however possible to make provision for the substrate mixture to comprise aggregates as additives.

Here, the definition of the aggregates is that given in standard XPP18-545. The aggregates comprise sand (grains with a maximum size Dmax of less than 4 mm, defined as undersize material), and gravel (grains or pebbles with a minimum size Dmin of greater than 4 mm, defined as oversize material).

In this case, preferably, the substrate mixture comprises sand but does not contain gravel. Preferably, the aggregates present have a maximum size Dmax of less than 3 mm, or even less than 2 mm and more particularly less than 1 mm. Preferably, the aggregates are present in the substrate mixture in a mass ratio of less than 20% or less than 10%, preferably less than 5%, more particularly preferably less than 2%, or even less than 1%.

Advantageously, provision can also be made in the substrate mixture for one or more additives conventionally used in the field, such as an accelerator and/or an air-entraining agent and/or a viscosity-increasing agent and/or a retarder and/or a clay neutraliser and/or a plasticizer.

Provision can also be made for the inclusion of a coloured hardener (ready-to-use mixture of cement, additives, aggregates with a shape and grain size selected for their physical and mechanical properties) and/or a mass water repellent compound (compound providing sealing against capillary rise and seepage) and/or a resin adhesive (solvent-free two-component epoxy resin that polymerises in dry or damp conditions).

It is also useful to include fibres, that is macrofibres (with a diameter in the region of 1 mm) or microfibres (with a diameter of between 50 μm and 1 mm) or a mixture of these. The fibres can be metal, synthetic or mineral. Polypropylene microfibres are particularly appropriate. The presence of fibres allows for the thickness of the substrate 2 to be reduced while retaining satisfactory compressive strength.

The mass ratio of the fibres (and particularly the microfibres) relative to the cement, within the wet substrate mixture, is preferably between 1:100 and 1:5, advantageously between 1:50 and 1:10, preferably between 1:25 and 1:12. A ratio in the region of 1:15 is particularly appropriate.

The volume ratio of the fibres in the wet substrate mixture can for example be between 0.1 and 10%, particularly between 1 and 5%.

The resulting wet substrate mixture can be a fibre-reinforced concrete (FRC) or an ultra-high performance fibre-reinforced concrete.

In general a substrate 2 with a thickness of between 0.2 and cm, preferably between 0.3 and 5 cm, more particularly preferably between 0.4 and 2 cm is chosen. A typical thickness of 1 cm is generally appropriate. However, in the event that the production of large decorative elements is desired, for example with an area greater than or equal to 1 m², it is appropriate to use a thickness of between 5 and 10 cm, and to include one or more metal reinforcements in the substrate 2 for increased strength.

After the deposition and forming of the substrate 2 from the substrate mixture, the substrate mixture is left to set, harden and dry. The drying can optionally be accelerated by heating and/or air blowing. The hard, dry substrate 2 thus obtained is formed from a material that comprises cement hydrates as well as calcium hydroxide and/or carbonate.

The term cement hydrates covers all of the types of mineral obtained through the hydration of the cement and in particular by hydration of the clinker component of the cement. In particular, cement contains as its main components tricalcium silicate (C₃S), dicalcium silicate (C₂S), tricalcium aluminate (C₃A) and aluminoferrite (C₄AF), and as minor components free lime and alkaline sulphates in particular.

Cement hydrates are therefore obtained by hydration of these components. The cement hydrates can for example comprise 40 to 80% by weight, preferably 50 to 70% by weight, of hydrated calcium silicates (HCS), and 20 to 40%: by weight, preferably 25 to 30% by weight of hydrated lime or calcium hydroxide Ca(OH)₂. This hydrated lime can also have been partially converted to the carbonated form (CaCO₃) by reaction with carbon dioxide.

The substrate 2 (optionally arranged on the base structure) can be prepared in advance and kept pending use for the production of the decorative element 1.

Next, an intermediate layer 3 is deposited and formed on the substrate 2. This intermediate layer 3 is obtained from a plaster comprising lime and water.

Preferably, the plaster in question comprises at least 70%, more particularly preferably at least 80%, advantageously at least 90%, ideally at least 95% by dry mass of lime. According to a particular embodiment, the plaster is obtained by mixing pure lime with water.

Air-slaked or hydraulic lime can be used as the lime.

Provision can also be made for one or more additives combined with the lime, in a total proportion of less than 30%, preferably less than 20%, advantageously less than 10%, ideally less than relative to the total dry mass of the plaster.

All of the additives mentioned above in relation to the substrate mixture can be used as additives, in particular fine sand or fibres (particularly microfibres). In addition, a surface deactivator or a coloured mineral grout (constituted of binders, calibrated quartz, polypropylene fibres, water-reducing plasticizer, plasticizer, colorant pigments and aggregates with a shape and grain size selected for their physical and mechanical properties) can be used.

The mass ratio of water in the plaster is preferably comprised between 40 and 80%, preferably between 50 and 70%, ideally between 55 and 65% and in particular in the region of around 60% relative to the total mass of the plaster.

The plaster is preferably applied by means of a spatula, a float, a round-nose trowel or any other means known to a person skilled in the art. Application can also be automated.

The intermediate layer 3 thus obtained preferably has a thickness of between 0.1 and 5 mm, in particular between 0.3 and 3 mm, more particularly preferably between 0.5 and 2 mm.

Generally, a person skilled in the art will adjust the thickness of the intermediate layer 3 to meet the external conditions, that is mainly the temperature and humidity conditions. At this stage the intermediate layer 3 must be prevented from drying too quickly. Consequently, in the event of low humidity for example, the intermediate layer 3 can advantageously be thicker than in the event of high humidity.

Generally, during the production of the decorative element, each layer can be obtained by gravitational settling, the lime (relatively light) migrating to the surface and the heavier grains (sand, etc.) migrating to the bottom. This phenomenon can be accelerated by the application of vibrations.

Once the intermediate layer 3 has been formed, a picture layer 7 can be applied. The picture layer 7 contains pigments and confers upon the decorative element the pictorial appearance sought, that is the appearance of a decorative image.

According to a first embodiment, the picture layer 7 consists of a single ink film forming an image. It is possible to provide to this end the application of ink or paint by hand or in an automated manner, using a paintbrush, a roller, a gun or other. However, the preferred application method consists of using a flatbed digital inkjet printer. Thus, very quick application can be enjoyed, allowing for extremely accurate high-resolution images to be produced, as all of the colours are applied essentially simultaneously. In addition, the quantity of ink applied is very small. Thus, an ink film 1 to 2 μm thick can be appropriate.

It is for example appropriate to use a computer-controlled digital piezoelectric inkjet printer.

The ink can contain organic (carbon-based) or metal (such as titanium oxide) pigments.

Preferably, the ink used is a photosensitive ink, that is, that will harden under the effect of ultraviolet radiation. Ultraviolet radiation is then used at the time of application of the ink, preferably automatically by the printer itself. Inks made by 3M or AGFA are for example appropriate.

It must be noted that the term “ink” as used here can generally denote several individual inks of different colours, used in combination or juxtaposed to produce all of the tones of colour necessary to produce the desired image.

Whatever method is selected to apply the ink, it is important that such application take place while the intermediate layer 3 is still damp, that is, before it has set and dried. The time period between the deposition of the intermediate layer 3 and the application of ink must be adjusted to this end. This time period depends on specific parameters of implementation of the production method, that is in particular the water content of the intermediate layer 3, its thickness, the lime content and lime quality and the external temperature and humidity conditions.

A person skilled in the art will be able to determine by visual inspection of the surface of the decorative element the correct moment for the application of the ink. Generally, when the surface is still damp, open pores are clearly visible. Furthermore, a simple test consisting of applying a sheet of paper to the surface can be used to reveal the dampness of the surface: if the sheet of paper sticks to the surface, this means that the surface is still damp.

The use of automatic devices to measure the dampness of the intermediate layer 3 known in the industry is also possible.

The application of at least one layer of ink on a damp substrate is essential for the adherence of the picture layer 7 to the decorative element 1, and for the durability of the object. The ensuing carbonation of the lime by reaction with the carbon dioxide in the air guarantees remarkable adherence of the pigments to the substrate and forms a genuine protective barrier. In this way, the pigments in the ink become truly incorporated into the substrate itself, with the lime acting as a binder for the pigments in the finished product.

It must be noted that it is still however possible to apply the ink to a dry substrate, which can simplify the production of the decorative element. The performance of the decorative element thus obtained is however poorer, and the rendering (“plastic” appearance typical of normal prints) is deemed less good by most users, although it can be preferred by certain users.

According to a second embodiment, the picture layer 7 comprises two separate Layers, namely a first ink film 4 directly deposited on the still-damp intermediate layer 3, together with an ink film 5 deposited on the first.

In this case, the first ink film 4 must be applied in the same humidity conditions of the intermediate layer 3 as those described above in relation to the first embodiment.

Advantageously, this first ink film 4 consists of a uniform layer of ink, for example a layer of white ink. A photosensitive titanium dioxide-based ink (particles of titanium dioxide) is particularly appropriate.

After the application of the first ink film 4, the decorative element 1 (and in particular the intermediate layer 3) can be left to dry completely. The ink film 4 then constitutes a surface available for the subsequent receipt of the second ink film 5. It is therefore possible to deposit the second ink film 5 at any time, without having to meet particular time constraints. Thus, the decorative element 1 can for example be stored, transported or even undergo intermediate sale, before the application of the second ink film 5.

In this case, the second ink film 5 is the one that is intended to form the image. Advantageously, it has the same characteristics as the film described above in relation to the first embodiment. The adherence of the second ink film 5 to the first ink film 4 is good as they have a similar composition. The problems linked to the application of ink directly onto a dry lime surface undergoing carbonation (powdery appearance of the surface) are not encountered here because the lime-based surface is already covered with a pigment layer.

The optional next stage consists of covering the picture layer 7 with a protective layer 6. This protective layer 6 is preferably colourless and transparent. It must be capable of protecting the surface of the object from dirt and wear. Preferably, the protective layer 6 is of the water repellent type, without however leading to total impermeability. It is desirable that the core of the decorative element 1 be able to continue to make chemical exchanges with the environment, particularly so that carbonation can continue.

This is why, although the use of a varnish or resin as a protective layer 6 can be envisaged, it is however preferable to use a wax, in particular a porous wax, which better meets the desired qualities. As an example, beeswax can be used, or preferably a concrete wax, for example wax of the Bestcire® type, which is an emulsion based on reticulated resin with metal ions and aqueous high polymers. Its various penetrating components allow it to achieve a remarkable patina as well as excellent resistance to traffic and water, accompanied by a beading effect on liquids.

Alternatively or in conjunction, a stain-resistant finishing resin can be used, which is a solvent-free single-component pore-blocking resin emulsion providing protection against excessive drying.

The protective layer 6 is preferably applied in a thickness of between 0.2 and 5 μm, preferably between 0.5 and 3 μm, more particularly preferably between 0.8 and 2 μm.

### Use of the Decorative Elements

The decorative elements produced in this way are useful for the production of large decorations, in particular mural decorations (although it is also possible to lay them on floors, ceilings or any other type of surface).

For this, the image that is to be applied as decoration must simply be split into individual parts, for example according to a grid, and then as many decorative elements as necessary must be produced, as described above, each decorative element being covered with an individual part of the image divided up in this way by means of the picture layer 7.

This operation is particularly easy using a computer and an associated digital printer.

Once the various decorative elements have been produced, the decorative elements must simply be fixed to the chosen support and assembled in the right order so that they reconstitute the desired image.

The decorative elements can be fixed by any means known to a person skilled in the art, for example by screwing, nailing or gluing. Preferably, the decorative elements are fixed using an adhesive mortar.

It is generally possible to assemble the decorative elements sufficiently accurately to avoid any jointing. If however joints are desired between the decorative elements, the use of a polyurethane-based synthetic material is appropriate, as such material can be dyed. Jointing is also possible using a lime plaster and then a coloured time wash on the surface, so that the joint shows as little as possible.

It can be useful to apply an additional protective layer to the decoration assembled in this way, whether or not the individual decorative elements already have a protective Layer 6. To this end, the use of the same type of material (in particular a porous wax of the concrete wax type) as for the protective layer 6 is advantageous.

It is noted that the carbonation of the lime continues for months or even years, therefore often even after the decorative elements have been laid. Consequently, their strength only increases over time. They also tend to acquire a characteristic patina over time, which is pleasant to look at and touch.

It must be noted that it is also possible to use a single decorative element in order to produce a decoration, in particular when the decorative element is large. It is then similar to a painting.

### Example

Decorative elements are produced according to the following protocol:
Digital image files are prepared on a computer.
Formwork is produced to form a mould for the substrate layer.
A mixture of 5 kg of Lafarge CEM2/B-LL 32, 5 RC P2 white cement, 5 kg of natural white hydraulic lime NHL 3, 5 z, 2.5 kg of fine sand and additives, and 11 litres of water is prepared. Alternatively, a mixture of 50% by mass of lime and 50% by mass of dry concrete (comprising ⅔ cement and ⅓ fine sand and additives) is prepared, with the addition of the corresponding quantity of water.
This preparation is cast in the mould to provide the substrate, or alternatively is used to coat a WEDI type building board.
The intermediate layer is prepared using pure lime, applied in a thin layer using a round-nose trowel and a wide spatula.
For a first sample, a direct flatbed print is produced by means of a computer-controlled ZUND 215 printer when the intermediate lime layer is still damp.
For a second sample, a first layer of ink is applied by hand when the intermediate lime layer is still damp, and then a direct flatbed print is produced using the printer once the decorative element is completely dry.
To finish, a layer of Bestcire® concrete wax is applied with a brush.

1. A decorative element comprising:
a substrate formed from a material comprising cement hydrates and calcium hydroxide and/or carbonate;
an intermediate layer arranged on the substrate, comprising calcium hydroxide and/or carbonate;
a picture layer arranged on the intermediate layer, comprising pigments.

2. The decorative element of claim 1, wherein the picture layer comprises:
at least one film of hardened photosensitive ink, of uniform colour or forming an image; and preferably
a first photosensitive ink film of uniform colour, arranged on the intermediate layer, together with a second photosensitive ink film forming an image, arranged on the first film.

3. The decorative element of claim 1, also comprising a base structure on which the substrate is arranged, said base structure preferably being a building panel or board.

4. The decorative element of claim 1, also comprising a protective layer arranged on the picture layer, preferably constituted of wax.

5. The decorative element of claim 1, wherein the material of the substrate comprises:
20 to 80%, preferably 30 to 70%, more particularly preferably 40 to 60%, ideally 45 to 55% by mass of cement hydrates; and
20 to 80%, preferably 30 to 70%, more particularly preferably 40 to 60%, ideally 45 to 55% by mass of calcium hydroxide and/or carbonate.

6. The decorative element of claim 1, wherein the intermediate layer comprises at least 60%, more particularly preferably at least 80%, advantageously at least 90%, ideally at least 95% by mass of calcium hydroxide and/or carbonate.

7. The decorative element of claim 1, wherein:
the substrate has a thickness comprised between 0.2 and 10 cm, preferably between 0.3 and 5 cm, more particularly preferably between 0.4 and 2 cm; and/or
the intermediate layer has a thickness comprised between 0.1 and 5 mm, preferably between 0.3 and 3 mm, more particularly preferably between 0.5 and 2 mm; and/or
the picture layer has a thickness comprised between 0.2 and 10 μm, preferably between 0.5 and 5 μm, more particularly preferably between 0.8 and 3 μm; and/or
the protective layer has a thickness comprised between 0.2 and 5 μm, preferably between 0.5 and 3 μm, more particularly preferably between 0.8 and 2 μm.

8. A method of producing a decorative element, comprising successively:
supplying a substrate formed from a material comprising cement hydrates and calcium hydroxide and/or carbonate;
supplying a plaster comprising lime and water;
forming an intermediate layer on the substrate by application of the plaster;
depositing pigments on the intermediate layer, said intermediate layer being damp during deposition; and
drying the intermediate layer.

9. The method of claim 8, also comprising producing beforehand the substrate by casting, setting and drying a wet substrate mixture comprising cement and lime, the cement and lime preferably being in a mass ratio of 1:4 to 4:1, particularly preferably 3:7 to 7:3, ideally 2:3 to or even 9:11 to 11:9.

10. The method of claim 9, wherein:
the wet substrate mixture is cast in a mould; or
the wet substrate mixture is poured onto a base structure, said base structure preferably being a building panel or board.

11. The method of claim 8, wherein the depositing of pigments consists of printing a photosensitive ink film forming an image, by means of a digital printer.

12. The method of claim 8 wherein the deposition of pigments is carried out by application of a film of photosensitive ink of uniform colour, the method preferably comprising an additional stage of deposition of pigments after the drying of the intermediate layer (a), preferably by printing a film of photosensitive ink forming an image, using a digital printer.

13. The method of claim 8, comprising a final stage of coating with protective material, preferably wax.

14. The method of claim 8, wherein the decorative element is according to claim 1.

15. A method of producing a decoration, comprising:
assembling and fixing one or more decorative elements of claims claim 1, said decorative elements being flat, on a flat surface, which is preferably a wall;
optionally, jointing the fixed decorative elements; and
optionally, applying a protective layer, preferably wax, on the fixed decorative elements.
